(19) United States
(12) Patent Application Publication
(10) Pub. No.: US 2025/0164963 A1
(43) Pub. Date: May 22, 2025

(54) SYSTEM AND METHOD FOR IMPLEMENTING POSITION-SYNCHRONIZED OUTPUT (PSO) CONTROL TECHNIQUES

(71) Applicant: Micro-Controle Spectra-Physics S.A.S., Beaune la Rolande (FR)

(72) Inventors: Christophe AHRENS, Beaune la Rolande (FR); Tom FARMER, Santa Ana, CA (US)

(73) Assignee: Micro-Controle Spectra-Physics S.A.S., Beaune la Rolande (FR)

(21) Appl. No.: 18/837,776

(22) PCT Filed: Dec. 22, 2022
(86) PCT No.: PCT/EP2022/087519

§ 371 Date: Aug. 12, 2024

(30) Foreign Application Priority Data
Feb. 16, 2022 (FR) FR2201373

(51) Int. Cl. G05B 19/402

(52) U.S. Cl. CPC G05B 19/402; G05B 2219/33135

(57) ABSTRACT

A control system for controlling a device operative to perform an operation on a workpiece based on a spatial relationship between the device and the workpiece, which is adjustable using at least one actuator, includes a primary node controller communicatively coupled to the device and at least one secondary node controller communicatively coupled to the primary node controller. Each secondary node controller is adapted to receive encoder feedback from the actuator, the encoder feedback representing a position of a mechanical load associated with an actuator of the at least one actuator, perform a data compression algorithm on the encoder feedback to encode the encoder feedback, generate data packets representing the encoder feedback, and transmit the data packets. The primary node controller can receive and decode the data packets and control an operation of the device based on the decoded data packets.

### TECHNICAL DOMAIN OF THE INVENTION

Embodiments of the present invention relate to systems and methods for implementing control techniques involving position-synchronized output (PSO).

### TECHNICAL BACKGROUND

PSO techniques are used with a motion control system to generate an PSO trigger signal that is synchronized to the feedback position of one or more actuators (e.g., driven by a servo motor). The PSO trigger signal is typically used as a trigger to cause a laser to emit a laser pulse (or to acuate some other device). Servo motors typically include a position feedback mechanism such as a rotary quadrature encoder (i.e., a type of incremental encoder), which generates quadrature feedback signals that emulate motor commutation signals associated with the servo motor, with the addition of an index pulse. See, e.g., FIG. 1, where the waveforms OUTA and OUTB represent the emulated motor commutation signals and the waveform OUTZ represents the index pulse. The quadrature feedback signals are output to a servo driver, which processes the OUTA, OUTB and OUTZ waveforms to determine the position of the encoder shaft of the encoder. The servo driver generates a unique, multi-bit word of data (typically consisting of at least 28 bits, also referred to as a “position data unit”) representing the position of the encoder shaft relative to a reference position (typically, a “home” position determined on startup). The servo driver transmits the position data unit as a position data packet embedded in a position feedback signal to a motion controller adapted to implement the PSO technique.

Circuitry in servo drivers have a maximum frequency response, which limits how rapidly position data signals can be generated and transmitted. Combined with the velocity of the application, the frequency response places a practical upper limit on the resolution that can be obtained for a particular motion system and encoder. In this case, the maximum frequency response of the servo driver is proportional to the servo motor velocity (e.g., measured in m/s) divided by the encoder resolution (e.g., measured in nm). Thus for a particular application using a PSO technique (also referred to herein as a “PSO application”), a compromise must be made between servo motor velocity and encoder resolution to ensure that the maximum frequency response of the servo driver is not exceeded. Failure to do so will result in position errors and degradation of the position feedback signal. However, certain PSO applications (e.g., involving laser processing) would benefit from a high servo motor velocity and high encoder resolution, necessitating servo drivers capable of generating position data signals at rates higher than conventional techniques provide.

### SUMMARY OF THE INVENTION

One embodiment described herein can be generally described as a control system for controlling a device operative to perform an operation on a workpiece based on a spatial relationship between the device and the workpiece, wherein the spatial relationship is adjustable using at least one actuator, the control system comprising a primary node controller communicatively coupled to the device, wherein the primary node controller is adapted to control an operation of the device and at least one secondary node controller communicatively coupled to the primary node controller. According to an embodiment of the present invention, at least one secondary node controller (or each secondary node controller) is adapted to: receive encoder feedback from the actuator, the encoder feedback representing a position of a mechanical load associated with an actuator of the at least one actuator, perform a data compression algorithm on the encoder feedback to encode the encoder feedback, generate data packets representing the encoder feedback, and transmit the data packets. According to an embodiment of the present invention, the primary node controller is further adapted to can receive the data packets, decode the data packets and control an operation of the device based, at least in part, on the decoded data packets.

According to an embodiment of the present invention, the control system further comprises the device.

According to an embodiment of the present invention, the device includes at least one selected from the group consisting of a laser and a sensor.

According to an embodiment of the present invention, the control system further comprises the at least one actuator.

According to an embodiment of the present invention, the at least one actuator includes a linear actuator.

According to an embodiment of the present invention, the at least one actuator is mechanically coupled to the workpiece.

According to an embodiment of the present invention, the control system further comprises a plurality of secondary node controllers.

According to an embodiment of the present invention, the control system further comprises a plurality of actuators.

### BRIEF DESCRIPTION OF THE FIGURES

FIG. 1 is a chart illustrating waveforms of emulated motor commutation signals for a quadrature encoder;

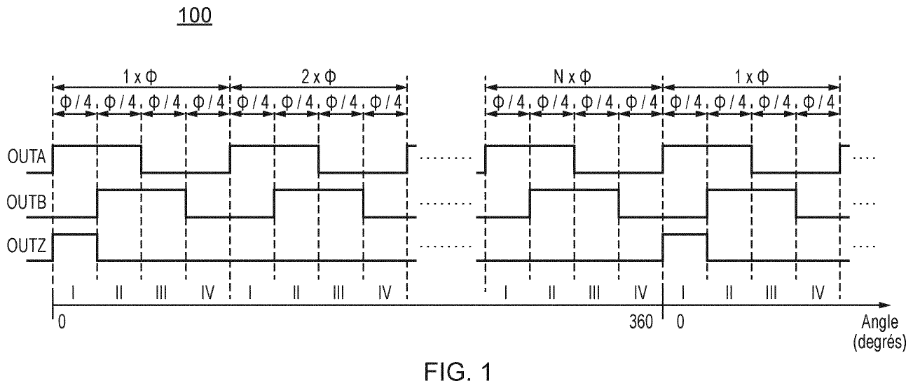

FIG. 2 schematically illustrates a workpiece-processing control system according to some embodiments of the present invention;

FIG. 3 is a cross-functional flow chart illustrating an exemplary process by which a PSO application can be executed, according to some embodiments of the present invention;

FIG. 4 is timing chart explaining, among other things, the information content of a hybrid position data packet conveyed by a position feedback signal according to one embodiment;

FIG. 5 is timing chart explaining how signals transmitted on various lines of a communication link can be synchronized according to one embodiment;

FIG. 6 is flow chart illustrating an exemplary process by which the position of an actuator corresponding to a secondary node controller may be determined, according to one embodiment.

### DETAILED DESCRIPTION OF THE INVENTION

Example embodiments are described herein with reference to the accompanying FIGS. Unless otherwise expressly stated, in the drawings the sizes, positions, etc., of components, features, elements, etc., as well as any distances therebetween, are not necessarily to scale, but are exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa. The section headings used herein are for organizational purposes only and are not to be construed as limiting the subject matter described.

Unless indicated otherwise, the term “about,” “thereabout,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

It will be appreciated that many different forms and embodiments are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

### I. Embodiments Concerning a Workpiece-Processing System, Generally

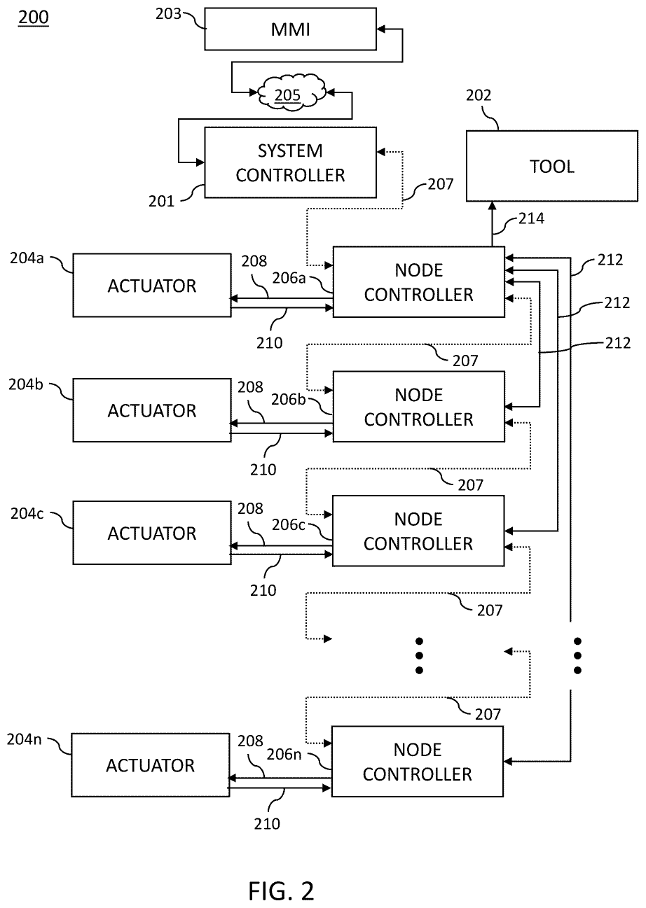

FIG. 2 schematically illustrates a workpiece-processing control system according to some embodiments of the present invention.

Referring to FIG. 2, a workpiece-processing system, such as system 200, is configured to carry out a position-synchronized output (PSO) application, whereby the operation of a tool (or a device) 202 is controlled based on the feedback position of one or more actuators 204a, 204b, 204c, 204n (also generically and collectively referred herein as an “actuator” or as “actuator” 204).

The tool 202 can be provided as a laser, an optical shutter, a camera, a sensor, an ultrasonic transducer, or the like. Accordingly, an operation that the tool 202 can be configured to perform can include: emitting a laser pulse (e.g., when the tool is a laser), transmitting light (e.g., when the tool is an optical shutter), capturing an image (e.g., when the tool is a camera), acquiring data (e.g., when the tool is a sensor), trigger a nondestructive test (e.g., when the tool is an ultrasonic transducer), and the like.

Generally, an actuator 204 can move the tool 202 relative to the workpiece or move the workpiece relative to the tool 202. Thus, an actuator 204 may be provided as motorized stage, a voice coil stage, piezoelectric stages, or the like, capable of moving the workpiece or the tool. Specific examples of such stages include linear stages, rotary stages, hexapod platforms, and the like. If the tool 202 is a laser, the actuator 204 can change the path along which the laser pulse can propagate (also referred to herein as a “propagation path”). In this case, the actuator 204 may be provided as galvanometer mirror (also known as a “galvo”), a polygonal mirror, or the like. For purposes of facilitating discussion of the embodiments described herein, it should be understood that an actuator 204 is provided as any suitable or known assembly of components that includes some type of motor capable of imparting motion (e.g., an electric motor, a voice coil, piezoelectric flexure, etc.) and a sensing device (e.g., an encoder) that provides feedback (e.g., in the form of a feedback signal) that can be used to determine position, count, speed, direction, or the like. According to embodiments described herein, the encoder can be provided as any suitable encoder, such as an AquadB incremental encoder, an analog sin/cos incremental encoder, or the like.

Generally, different actuators 204 may be arranged and configured to impart motion along different axes, or along a common or parallel axis. In this case, the actuators 204 are typically operated in a synchronized manner (using any motion control technique that is suitable or known in the art) to ensure desired movement of the workpiece, tool and/or propagation path in one or more spatial dimensions.

Generally, the system 200 includes a system controller 201 and a plurality of node controllers 206a, 206b, . . . 206n (also generically and collectively referred herein as a “node controller” or as “node controllers” 206), wherein each node controller 206 is communicatively coupled to a corresponding actuator 204. Although FIG. 2 illustrates an embodiment of a system 200 having “n” sets actuators 204 and node controllers 206 (where n is an integer greater than three), it will be appreciated that the system 200 may have only two or three sets of actuators 204 and node controllers 206.

The system controller 201 is configured to define the manner with which the tool 202 and actuators 204 are operated to carry out or execute a PSO application relative to a workpiece. Accordingly, the system controller 201 executes any suitable or known motion control technique to define the manner in which any actuator 204 is operated to move the workpiece, the tool 202 and/or propagation path (e.g., if the tool 202 is a laser). The system controller 201 can also define the manner in which the tool 202 is operated (e.g., based on a spatial relationship between the tool 202 and the workpiece) to perform the PSO application. The system controller 201 may be provided as any known or suitable controller capable of generating and transmitting device commands according to one or more protocols such as EtherCAT, Profinet, EtherNET/IP, Powerlink, SERCOS III, Modbus TCP, CC-Link IE, or the like. The system controller 201 may be communicatively coupled to a motion machine interface (MMI) 203 (e.g., via a network 205) that enables a user to interact with the system 200 in any manner known in the art. Alternatively, the MMI may be embedded within the system controller 201.

Device commands output by the system controller 201 are transmitted to the node controllers 206 via one or more communications links 207, which may be wired or wireless, serial or parallel. Although the communications links 207 of the system 200 are illustrated as a network having a line topology, it will be appreciated that the communications links 207 may rearranged into any other suitable or desired network topology (e.g., tree, ring, star, etc).

Each node controller 206 is communicatively coupled (e.g., via one or more wired or wireless, serial or parallel, communications links, as known in the art) to a corresponding actuator 204. Further, each node controller 206 is configured to control an operation of its corresponding actuator 204 (e.g., in response to a received device command, as discussed above). For example, node controller 206a is configured to control an operation of actuator 204a (as indicated by arrow 208 therebetween), node controller 206b is likewise configured to control an operation of actuator 204b, and so on. Each node controller 206 may be provided as any known or suitable device (e.g., servo motor, etc.) capable driving an actuator 204 in response to device commands output by the system controller 201. In addition, each node controller 206 may include one or more processors and tangible media (e.g., computer memory) accessible to the processor(s), to implement the function of both a primary node controller 206′ or a secondary node controller 206″ (both of which are described in greater detail below), depending upon whether the tool 202 to be operated according to a PSO application is communicatively coupled thereto.

A processor can be provided as a programmable processor (e.g., including one or more general purpose computer processors, microprocessors, digital signal processors, or the like or any combination thereof) operative to execute instructions to implement the functions of the primary node controller 206′ and secondary node controller 206″ described below. Instructions executable by the processor(s) may be implemented software, firmware, etc., or in any suitable form of circuitry including programmable logic devices (PLDs), field-programmable gate arrays (FPGAs), field-programmable object arrays (FPOAs), application-specific integrated circuits (ASICs)—including digital, analog and mixed analog/digital circuitry—or the like, or any combination thereof. Execution of instructions can be performed on one processor, distributed among processors, made parallel across processors within a device or across a network of devices, or the like or any combination thereof. Computer memory includes magnetic media (e.g., magnetic tape, hard disk drive, etc.), optical discs, volatile or non-volatile semiconductor memory (e.g., RAM, ROM, NAND-type flash memory, NOR-type flash memory, SONOS memory, etc.), etc., and may be accessed locally, remotely (e.g., across a network), or a combination thereof. Generally, the instructions may be stored as computer software (e.g., executable code, files, instructions, etc., library files, etc.), which can be readily authored by artisans, from the descriptions provided herein, e.g., written in C, C++, Visual Basic, Java, Python, Tel, Perl, Scheme, Ruby, assembly language, hardware description language (e.g., VHDL, VERILOG, etc.), etc. Computer software is commonly stored in one or more data structures conveyed by computer memory.

Any actuator 204 may transit data or information, such as a feedback signal (e.g., conveying information derived from a feedback position of the actuator, as will be described in greater detail below) to its corresponding node controller 206, as indicated by any arrow 210 therebetween.

If a node controller 206 is communicatively coupled to a tool that is to be operated in response to a PSO trigger signal, such as tool 202, then its corresponding node controller 206 is referred to herein as a “primary node controller” (e.g., designated herein by reference numeral 206′). Otherwise, a node controller 206 is referred to herein as a “secondary node controller” (e.g., designated herein by reference numeral 206″). Thus, in the example embodiment shown in FIG. 2, the node controller 206a can be considered a primary node controller (also designated herein by reference numeral 206′) and the node controllers 206b, 206c, . . . , 206n can each be considered a secondary node controller 206″.

When executing a PSO application according to embodiments of the present invention, the generation of a PSO trigger signal at the primary node controller 206′ is synchronized with (i.e., made conditional upon) position feedback signals output by one or more of the secondary node controllers 206″. Synchronized operation of the primary node controller 206′ with the secondary node controller(s) 206″ is facilitated by transmitting data over communications links 212 (e.g., each provided as one or more wired or wireless, serial or parallel, communications links, as known in the art). In one embodiment, the communication link 212 is provided as an ethernet patch cable (e.g., terminated with RJ45 connectors).

### II. Embodiments Concerning Processes for Executing PSO Applications

As mentioned above, the rate with which servo drivers generate and transmit position data signals is limited, which constrains how fast actuators can be driven and/or how fine encoder resolution can be. Thus, and as will be described in greater detail below, embodiments of the present invention may overcome the constraints conventionally placed on actuator velocity and/or encoder resolution in PSO applications by implementing a control technique in which data packets representing different position-based characteristics associated with one or more actuators are generated, transmitted and processed.

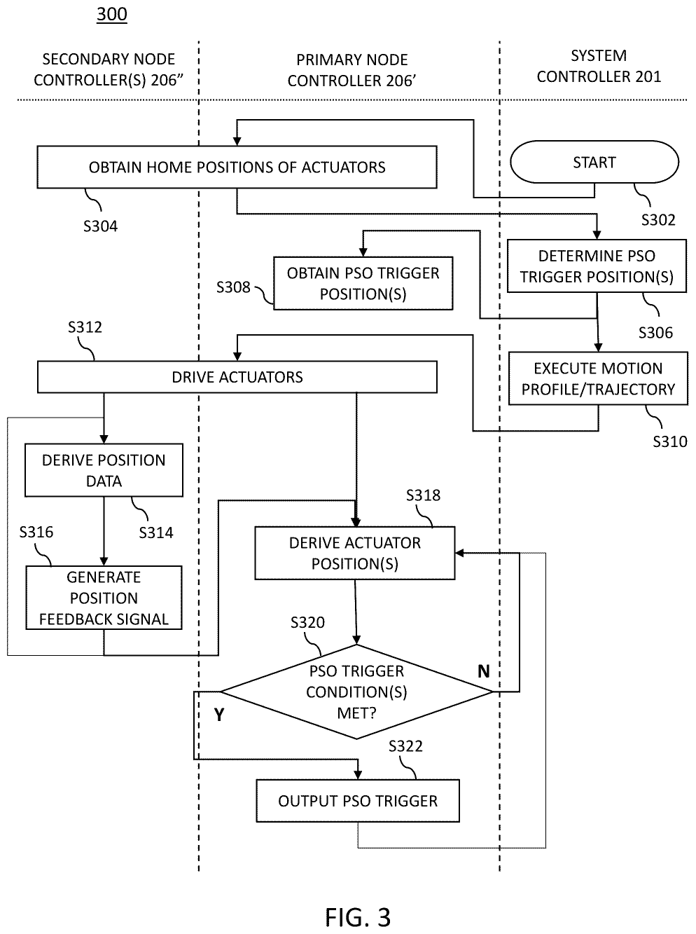

FIG. 3 is a cross-functional flow chart illustrating an exemplary process by which a PSO application can be executed, according to some embodiments of the present invention.

Referring to FIG. 3, a process for executing a PSO application, such as process 300, can be distributed between the system controller 201, a primary node controller 206′ (and its corresponding tool 202) and at least one secondary node controller 206″ (and at least one corresponding actuator 204). To facilitate description of the process 300, the discussion below will continue with the example configuration of devices 202 and node controllers 206 given above, i.e., node controller 206a is a primary node controller 206′, and node controllers 206b, 206c, . . . , 206n are secondary node controllers 206″.

At S302, the process 300 begins or starts with a pre-processing step in which a homing command is transmitted from the system controller 201 to each node controller 206 in the system 200 to initiate a homing process.

At S304, in response to the homing command, each node controller 206 operates its corresponding actuator 204 (e.g., by transmitting an electrical drive current to the actuator 204), and feedback signals generated by the sensing device of the actuator 204 are output back to the node controller 206 (e.g., as indicated by arrow 210 shown in FIG. 2). The node controller 206 then processes the feedback signals to derive a home position data unit fully representing the position of its corresponding actuator 204 before a desired motion profile or trajectory is executed (i.e., a “home” position of the actuator 204). In embodiments in which the sensing device includes an encoder, the home position of the actuator may be represented as a position of the encoder shaft of the encoder. The home position is then transmitted from each node controller 206 to the system controller 201 (e.g., via one or more communication links 207 shown in FIG. 2). Therefore, at S304, it is obtained the home position of some or all of the actuators.

At S306, after receiving home position data units associated with each actuator 204, the system controller 201 determines at least one PSO trigger position for one or more actuators 204. As used herein, a “PSO trigger position” corresponds to a position attained by an actuator 204 (e.g., determined, at least partly, based on feedback provided by the sensing device of the actuator, as is known in the art) when a PSO trigger signal is desired or otherwise determined to be output to the tool 202. When a PSO trigger signal is to be output (and, thus, when the tool 202 is to be operated), the relative position of the workpiece and tool 202 (or of the workpiece and propagation path) is such that a desired portion of the workpiece will be subjected to the operation of the tool 202. Thus, at a PSO trigger position, a desired portion of the workpiece will be: irradiated with a laser pulse (e.g., if the tool is a laser), exposed to light (e.g., if the tool is an optical shutter), imaged (e.g., if the tool is a camera), sensed (e.g., if the tool is a sensor), nondestructively tested (e.g., if the tool is an ultrasonic transducer), or the like. As will be appreciated, a group of related PSO trigger positions for at least some of the actuators 204 may be attained at least substantially simultaneously when executing a PSO application.

In one embodiment, a PSO trigger position for an actuator 204 may be determined by adding the home position of the actuator 204 to a preliminary PSO trigger position corresponding to the actuator 204. In this case, the preliminary PSO trigger position may be obtained or derived from a data file or data structure or object that is accessible to the system controller 201 and which describes the desired operation of a tool (as described above) in coordination with a desired motion profile or trajectory to be effected by driving one or more actuators 204. The system controller 201 transmits the PSO trigger position(s) to the primary node controller 206′ (e.g., via communication link 207) where they are stored (see S308). Then, at S308, trigger position(s) is/are obtained.

At S310, the motion profile/trajectory is executed. At S310, one or more actuator device commands are transmitted from the system controller 201 to each secondary node controller 206″ in the system 200 to move the workpiece, tool and/or propagation path (e.g., according to a motion profile). It should be appreciated that a series of actuator device commands may be transmitted over time (e.g., periodically or otherwise) to any secondary node controller 206″ to effect desired movement of the workpiece, tool and/or propagation path. Generally, device actuator commands are transmitted (e.g., at a rate of 2.5 kHz, or thereabout) to the secondary node controller(s) 206″ after the PSO trigger positions have been transmitted to the primary node controller 206′ at S308.

At S312, and in response to a received actuator device command, each node controller 206 drives its corresponding actuator 204 (e.g., to move the workpiece, tool and/or tool path, as described above). Generally, a node controller 206 may drive its corresponding actuator 204 by transmitting an electric drive current to the actuator 204, wherein the amplitude of the electric transmitted drive current may vary at a rate of up to 10 kHz (or thereabout).

At S314, feedback signals generated by the sensing device of the actuators 204 driven at S312 are output to their respective node controllers 206 (e.g., in the manner described above). Each node controller 206 interprets or otherwise processes the feedback signals to derive position data representing the position of its corresponding actuator (e.g., in the manner described above).

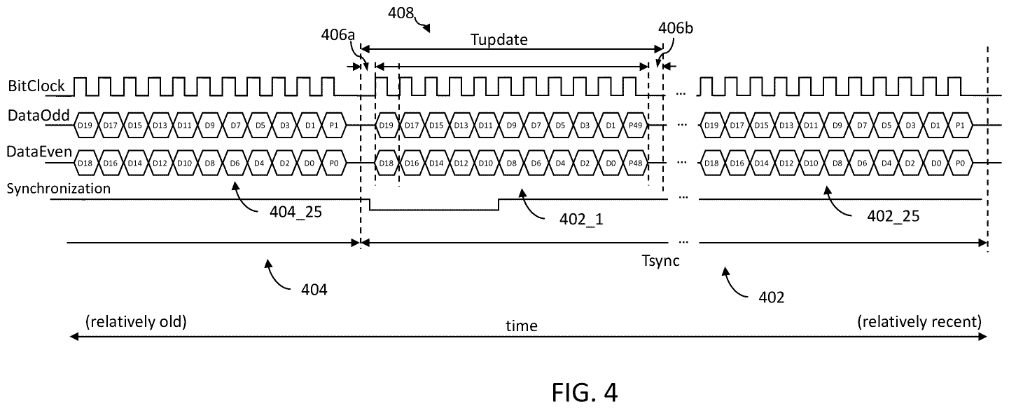

At S316, the secondary node controller 206″ generates a position feedback signal, which is transmitted to the primary node controller 206′ (e.g., via communication link 212). Like conventional servo drivers, the secondary node controller 206″ has an inherent maximum frequency response. However, to overcome the aforementioned constraints that the maximum frequency response could place on actuator velocity and/or encoder resolution, the position feedback signal generated by the secondary node controller 206″ conveys a hybrid position data packet representing different position characteristics of the actuator. Additional discussion concerning the hybrid position data packet and position feedback signal is provided below with respect to FIG. 4. In view of the foregoing, it will be appreciated that steps S314 and S316 are repeatedly performed for as long as actuators 204 are being driven by their respective secondary node controllers 206″. For example, step S314 can be performed periodically (e.g., at an update rate, as will be described in greater detail below) and S316 can be performed periodically (e.g., at a rate of 2.5 MHz, or thereabout).

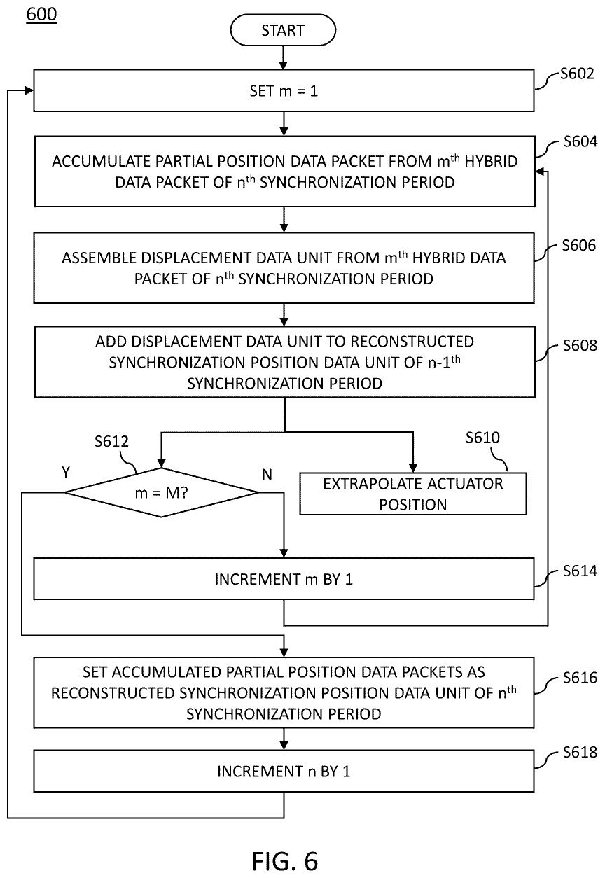

At S318, the primary node controller 206′ derives the position of one or more (or all) actuators 204 in the system 200. Thus, the primary node controller 206′ can derive the position of its corresponding actuator 204 and/or the current position of an actuator 204 corresponding to one or more (or all) of the secondary node controllers 206″. Generally, the position of any actuator 204 can be derived at a rate of up to 100 MHz (or thereabout). This step S318 will be described in greater detail below with respect to FIG. 6.

At S320, the primary node controller 206′ determines whether the position of any actuator 204 (as derived at S318) meets a predetermined PSO trigger condition. In one embodiment, a PSO trigger condition is met if the position of any actuator 204 derived at S318 is equal to (or about equal to) a PSO trigger position associated with the actuator 204 obtained at S308. In another embodiment, a PSO trigger condition is met if the position of any actuator 204 derived at S318 is not equal to (or about equal to) a PSO trigger position associated with the actuator 204, but is within a predetermined range of the PSO trigger position. The predetermined range may be fixed or variable. The criteria of the PSO trigger condition can be stored at the primary node controller 206′, e.g., based on data transmitted by the system controller 201 (via one or more communication links 207) in any manner that is suitable or known in the art.

If the PSO trigger condition is met, then (at S322) the primary node controller 206′ generates a PSO trigger signal that can be transmitted (or outputted) to tool 202 (e.g., as indicated by arrow 214 shown in FIG. 2). The PSO trigger signal is then used as a trigger to operate the tool 202 (e.g., as described above) and the process returns to step S318. If the PSO trigger condition is not met, then the primary node controller 206′ does not generate an output signal and the process then returns to S318. Generally, determinations at S320 can be made at a rate of up to 100 MHz (or thereabout).

### III. Embodiments Concerning the Hybrid Position Data Packet and Position Feedback Signal

FIG. 4 is timing chart (relatively recent times on the right side of the timing arrow at the bottom of FIG. 4 and relatively old times at the left side of the timing arrow at the bottom of FIG. 4) explaining, among other things, the information content of a hybrid position data packet conveyed by a position feedback signal according to one embodiment. FIG. 4 shows lines labeled “DataOdd” and “DataEven.” These lines are included as part of each communication link 212 shown in FIG. 2. FIG. 4 also shows numerous hexagons, which represent bits of multi-bit words of data that are transmitted over the communication link 212. The DataOdd line transmits odd-numbered bits of a word of data and DataEven transmits even-numbered bits of the word of data. Thus, the signals transmitted over the DataOdd and DataEven lines can be conceptually considered to collectively constitute a common signal (i.e., the position feedback signal output from the secondary node controller 206″). Accordingly, and as will be described in greater detail below, corresponding sets of bits conveyed in the signals transmitted by the DataOdd and DataEven lines can be conceptually considered to collectively constitute a common hybrid position data packet output by the secondary node controller 206″. It will be appreciated that the primary node controller 206′ can be configured and operated in any manner known in the art to process the bits conveyed by the DataOdd and DataEven lines to effect the processes described herein (e.g., including process steps S318, S320 and S322).

As mentioned above, the position feedback signal generated by each secondary node controller 206″ conveys a hybrid position data packet, which represents different position characteristics of its respective actuator 204, and is transmitted from a secondary node controller 206″ to the primary node controller 206′ periodically. The different position characteristics represented by any hybrid position data packet will include: a partial position data packet representing a portion of a synchronization position data unit that fully describes the position of the corresponding actuator 204 at a given point in time (also herein referred to as a “synchronization timepoint”); and a displacement data packet representing a displacement in the position of the actuator 204 at a given point in time (also herein referred to as an “update timepoint” occurring at the beginning of, or otherwise corresponding to, an update period) relative to the position of the actuator 204 at a synchronization timepoint.

As shown in FIG. 4, and within any hybrid position data packet, a first set of bits (i.e., bits having labels beginning with “P”) are bits in the partial position data packet, and a second set of bits (i.e., bits having labels beginning with “D”) are bits in the displacement data packet.

On a long enough timeline, a position feedback signal conveys a sufficient number of consecutively-created hybrid position data packets, and thus a sufficient number of partial position data packets, to represent an entire synchronization position data unit. The period of time necessary to accumulate a complete set of partial position data packets fully representing the synchronization position data unit is herein referred to as a “synchronization period.” A synchronization timepoint can mark the beginning of, or otherwise occur during, a synchronization period. For purposes of facilitating discussion, the latest or most recent synchronization period is referred to as a “current” synchronization period and the synchronization period immediately preceding the current synchronization period is referred to as a “preceding” synchronization period.

Partial position data packets of different hybrid position data packets conveyed during a common synchronization period represent different portions of a common synchronization position data unit. Displacement data packets conveyed in hybrid position data packets during a current synchronization period represent various displacements in the position of the actuator 204 at various update timepoints relative to the position of the actuator 204 at a synchronization timepoint of a preceding synchronization period (herein referred to as a “preceding synchronization timepoint”).

The number following a “P” or “D” of any bit is an ordinal number identifying the position of the bit in either a synchronization position data unit or a displacement data unit, respectively corresponding to the partial position data packet or displacement data packet in which it is found. For example, for any bit labelled “P0” or “D0,” the number “0” indicates that the bit is the least significant bit (LSB) (also referred to as the “low-order bit” or “right-most bit”) in the data unit. For any bit labelled “P49” or D19, the numbers “49” and “19” indicate that the bits are the most significant bit (MSB) (also referred to as the “high-order bit” or “left-most bit”) in their respective data units.

The foregoing will be more clear in light of the additional description relative to FIG. 4 below, which illustrates a plurality of hybrid position data packets: e.g., a first hybrid position data packet 402_1 and a twenty-fifth hybrid position data packet 402_25, each conveyed during a common synchronization period 402. Although not illustrated, a sequence of additional hybrid position data packets (i.e., second, third, fourth, . . . twenty-fourth) would also be consecutively-conveyed after the first hybrid position data packet 402_1 and before the twenty-fifth hybrid position data packet 402_25. A twenty-fifth hybrid position data packet 404_25 conveyed during a synchronization period 404, which precedes synchronization period 402, is also illustrated. Thus in the illustrated example, each synchronization period is composed of “M” number of update periods (and, thus, “M” number of hybrid position data packets), where “M” is equal to twenty-five. It should be appreciated however, that “M” can be any other integer equal to 2, 3, 4, 5, 10, 15, 20, 30, 40, 50, etc., or between any of these values.

As shown in FIG. 4, the partial position data packet of the first hybrid position data packet 402_1 includes a first pair of bits (i.e., bits P48 and P49) of a synchronization position data unit that fully describes the position of an actuator 204 at a given synchronization timepoint marking the beginning of the synchronization period 402. Likewise, the partial position data packet of the twenty-fifth hybrid position data packet 402_25 includes a twenty-fifth pair of bits (i.e., bits P0 and P1) of the aforementioned synchronization position data unit. Although not illustrated, the partial position data packets of the second, third, fourth, etc., hybrid position data packets would also include second, third, fourth, etc., pairs of bits (i.e., bits P46 and P47, P44 and P45, P42 and P43, etc.) in the aforementioned synchronization position data unit. The partial position data packet of the twenty-fifth hybrid position data packet 404_25 includes a twenty-fifth pair of bits (i.e., bits P0 and P1) of a synchronization position data unit that fully describes the position of an actuator 204 at a synchronization timepoint marking the beginning of the synchronization period 404.

As also shown in FIG. 4, the second set of bits in the displacement data packet of each hybrid position data packet includes bits D0, D1, . . . . D19, which correspond to bits describing the displacement in the position of the actuator 204 at a given update timepoint during a current synchronization period relative to the position of the actuator 204 at a synchronization timepoint of a preceding synchronization period. Thus, the displacement data packets in hybrid position data packets 402_1 to 402_25 include bits describing the displacement in the position of the actuator 204 at first to twenty-fifth update timepoints during synchronization period 402 relative to the position of the actuator 204 at a synchronization timepoint of synchronization period 404, which immediately preceded synchronization period 402. Likewise, the displacement data unit in hybrid position data packet 404_25 includes bits describing the displacement in the position of the actuator 204 at a twenty-fifth update timepoint during synchronization period 404 relative to the position of the actuator 204 at a preceding synchronization timepoint of synchronization period that preceded synchronization period 404.

It will be appreciated that the number and/or duration of each update period (Tupdate) and, thus, the duration of each synchronization period (Tsync) may depend upon one or more factors such as the bit lengths of each of the synchronization position data unit, the number of bits in the partial position data packet and displacement data packet, the operational frequency of the sensing device in each actuator, the operational frequency of the node controller 206, sensing device input frequency, maximum bit clock frequency allowed by the physical links (cables, transceivers, etc.), signal jitter affecting minimum idle time between hybrid position data packets (see, e.g., start period 406a and end period 406b), and the like. Generally, the update period can have a duration, Tupdate, in a range from 50 ns (or thereabout) to 500 ns (or thereabout), such as 100 ns, 150 ns, 200 ns, 250 ns, 300 ns, 400 ns, etc., or between any of these values, but may be shorter than 50 ns or longer than 500 ns. Thus, the synchronization period can have a duration, Tsync, in a range from 1 μs (or thereabout) to 12 μs (or thereabout), such as 3 μs, 5 μs, 7 μs, etc., or between any of these values, but of course may be shorter than 1 μs or longer than 12 μs. Given a particular duration of the update period, bits for a new hybrid position data packet can be considered to be determined at an update rate that is the inverse of the update period (e.g., in a range from 2 MHz (or thereabout) 20 MHz (or thereabout)). Likewise, given a particular duration of the synchronization period, a complete set of partial position data packets fully representing a synchronization position data unit can be accumulated at a synchronization rate that is the inverse of the synchronization period (e.g., in a range from 83 kHz (or thereabout) 1 MHz (or thereabout)).

In the example embodiment described above with respect to FIG. 4, the bit length of the synchronization position data unit is 50 bits (which may include a payload and a few bits, e.g., 4 bits for parity/CRC error detection), but it will be appreciated that the bit length of the synchronization position data unit may be more than 50 bits, or less (e.g., 16 bits, 32 bits, 64 bits, etc., or any value therebetween). Likewise, although the bit length of the partial position data packet is 2 bits, it will be appreciated that the bit length of the partial position data packet may be only one bit, or may be more than 2 bits. Lastly, although the bit length of the displacement data unit is 20 bits (which may include at least one bit for parity/CRC error detection), it will be appreciated that the bit length of the displacement data unit may be more than 20 bits, or less (e.g., 4 bits, 8 bits, 16 bits, 24 bits, 30 bits, etc., or any value therebetween), so long as the bit length of the displacement data unit is less than the bit length of the synchronization position data unit.

### A. Additional Discussion Concerning Lines and Signals

In addition to the DataOdd and DataEven lines, FIG. 4 shows lines labeled “BitClock” and “Sync.” These lines are included as part of each communication link 212 shown in FIG. 2. In embodiments in which the communication links 212 are each provided as an ethernet patch cable as described above, the various lines of each communication link 212 (i.e., the DataOdd, DataEven, BitClock and Synchronization lines) may each be provided as a twisted pair of wires, as is known in the art.

i. The Bit Clock Line and Signal

A bit clock signal is generated and transmitted from each secondary node controller 206″ to the primary node controller 206′ over the BitClock line. The primary node controller 206′ may also generate a bit clock signal, though it is not transmitted over a communication link 212. Generally, the bit clock signal is generated by an internal bit clock of each node controller 206 (i.e., the primary node controller 206′ and each secondary node controller 206″), and corresponds to the operational frequency of the node controller 206. In some embodiments, the operational frequency of the bit clock (also herein referred to as a “bit clock frequency”), and thus of the bit clock signal, can be in a range from 25 MHz to 200 MHZ (e.g., 50 MHz, 100 MHz, 200 MHZ, etc., or between any of these values). It should be recognized that the bit clock frequency may be lower than 25 MHz or higher than 200 MHz depending on the configuration of components such as the node controllers 206, the communication links 212, and the like.

Transmission of the bits on the DataOdd and DataEven lines from a secondary node controller 206″ can be synchronized to the bit clock signal. Furthermore, operations of the primary node controller 206′ and each secondary node controller 206″ within a synchronization period can be synchronized to one another using the bit clock signal. For example, the secondary node controller 206″ can clock out data on the rising edge of the bit clock signal and the primary node controller 206′ can clock in data on the falling edge of the bit clock signal. Optionally, the primary node controller 206′ can mitigate any potential metastabilities arising from a bit clock signal (as received from a secondary node controller 206″) rolling in phase relative to the bit clock signal of the primary node controller 206′ by any technique suitable or known in the art.

As will be appreciated, it is generally important the timing relationship between signals output from a secondary node controller 206″ on the DataOdd and DataEven lines is maintained within a certain tolerance (e.g., within 5 ns, or thereabout) relative to the bit clock signal transmitted on the BitClock line. Temporal drift out of tolerance can be caused by one or more factors such as the physical length of the lines, unequal signal path delays in the signal outputs of the secondary node controller 206″, unequal signal path delays in the signal inputs of the primary node controller 206′, duty cycle distortion in the transceiver and other circuitry of each node controller 206 and temperature variation of the node controller 206 and lines in communication link 212. To reduce potentially-deleterious effects of an unacceptable amount of drift relative to the bit clock signal, the DataOdd and DataEven lines have different twist ratios from each other, and the twist ratio of the BitClock line is between the twist ratios of the DataOdd and DataEven lines. By providing the twist ratio of the BitClock line to be between the twist ratios of the DataOdd and DataEven lines, the total drift between DataOdd and DataEven lines will be divided with respect to the bit clock signal transmitted on the BitClock line. That is, a data signal on one of the DataOdd and DataEven lines may drift temporally forward relative to the bit clock signal while the data signal on the other of the DataOdd and DataEven lines drifts temporally backward relative to the bit clock signal.

Furthermore, the bit clock signal can also be used to communicate the beginning of a hybrid position data packet in the position feedback signal. For example, as shown in FIG. 4, the bit clock signal may be in a static logic state ‘0’ for an extended period of time 406a (also referred to herein as a “packet start period”). The primary node controller 206′ may synchronize its internal bit clock to change in logic state from logic state ‘0’ to logic state ‘1’ at the end of the packet start period 406a.

ii. The Synchronization Line and Signal

A synchronization signal is transmitted from the primary node controller 206′ to each secondary node controller 206″ over the Synchronization line. In general, the synchronization signal has a frequency corresponding to the synchronization period, and the duty cycle of the synchronization signal commands how the secondary node controllers 206″ are be operated. That is, the operational mode of any secondary node controller 206″ corresponds to the duty cycle of the synchronization signal it receives from the primary node controller 206′. Generally, the synchronization signal has a frequency much lower than that of the bit clock signal. For example, the synchronization signal can have a frequency in a range from 50 kHz to 400 kHz (e.g., 100 kHz, 200 kHz, 300 kHz, etc., or between any of these values). Example operational modes include a “stand-by” mode, a “training” mode and a “normal” mode. Additional discussion regarding these operational modes will be provided in greater detail below.

### B. Additional Discussion Concerning Deriving Actuator Positions (S318)

As mentioned above with respect to S318 in FIG. 3, the primary node controller 206′ interprets or otherwise processes hybrid position data packets conveyed in the received position feedback signal to derive the position of each actuator 204 corresponding to a secondary node controller 206″. The position of an actuator 204, as represented by a position data unit, is stored at the primary node controller 206′. As will be appreciated, the position of an actuator 204 may be derived differently depending upon whether the actuator 204 corresponds to a primary node controller 206′ or a secondary node controller 206″.

i. Deriving Position of Actuator Corresponding to Primary Node Controller

To derive the position data unit associated with an actuator 204 corresponding to the primary node controller 206′, the primary node controller 206′ simply processes the feedback signals communicated by its corresponding actuator 204 (e.g., at the synchronization time point associated with a synchronization period) to generate a position data unit fully representing the position of its corresponding actuator 204. As mentioned previously, feedback signals are transmitted from an actuator 204 to its corresponding node controller 206 at a rate of 5 MHz (or thereabout). Thus, in one embodiment, the primary node controller 206′ can derive position units for its corresponding actuator 204 at a rate of 5 MHz (or thereabout). In another embodiment however, the primary node controller 206′ can process the feedback signals to extrapolate the position of its corresponding actuator 204 at a rate greater than 5 MHz (e.g., at an extrapolation rate of up to 100 MHz or thereabout) by any suitable or known technique. Thus, the primary node controller 206′ can derive position units for its corresponding actuator 204 at a rate of up to 100 MHz (or thereabout).

The position data unit derived at S318 is stored at the primary node controller 206′ (e.g., in a data structure associating the current position data unit with the primary node controller 206′). Any data position unit that is already stored in the data structure for the actuator 204 corresponding to the primary node controller 206′ is overwritten by the new data position unit for the actuator 204.

ii. Deriving Position of Actuator Corresponding to Secondary Node Controller

To derive the position data unit of an actuator 204 corresponding to a secondary node controller 206″, the primary node controller 206′ sequentially processes hybrid position data packets conveyed in the position feedback signal that is received from a secondary node controller 206″. An example embodiment in which the sequentially-conveyed hybrid position data packets in a position feedback signal, transmitted from each secondary node controller 206″, are processed at the primary node controller 206′ is described in greater detail with respect to process 600 as shown in FIG. 6.

Referring to FIG. 6, “n” represents an ordinal number of a synchronization period in a position feedback signal transmitted from a secondary node controller 206.” Thus, “n” can be any integer greater than or equal to one. Likewise, “m” represents an ordinal number of an update period during a synchronization period. Thus “m” also represents the ordinal number of a hybrid position data packet conveyed during a synchronization period. As discussed above, “M” represents the total number of update periods (and, thus, hybrid position data packets) in each synchronization period. Accordingly, “m” can only be less than or equal to “M.”

At S604 (accumulate partial position data packet from m^{th} hybrid data packet of n^{th} synchronization period), the primary node controller 206′ processes an m^{th} hybrid position data packet conveyed during an n^{th} synchronization period (e.g., a 1^{st} synchronization period) to extract bits of the partial position data packet conveyed therein.

As indicated at S602, m is set at 1 and the first hybrid position data packet conveyed during any particular synchronization period will be the first hybrid position data packet to be processed at S604. Extracted bits of the partial position data packet can be stored at the primary node controller 206′ in a data structure in association with: the secondary node controller 206″ from which it was transmitted; and the location where the bits in the partial position data packet are assigned within the synchronization position data unit.

At S606 (assemble displacement data unit from m^{th} hybrid data packet of n^{th} synchronization period), the primary node controller 206′ processes the m^{th} hybrid position data packet conveyed during the n^{th} synchronization period to extract bits of the displacement data packet conveyed therein. Extracted bits in the displacement data packet are then assembled into a displacement data unit (i.e., a multi-bit word of data, as described above).

At S608 (add displacement data unit to reconstructed synchronization position data unit of n-1^{th} synchronization period), the displacement data unit obtained at S606 is added to a synchronization position data unit (also a multi-bit word of data, as described above) associated with a preceding synchronization period (i.e., an n-1^{th} synchronization period). The resultant multi-bit word of data is a position data unit representing a derived position of an actuator 204, which can be stored at the primary node controller 206′ in a data structure in association with the corresponding secondary node controller 206″ from which the hybrid position data packet was received and, optionally, also in association with an internal timestamp value generated by the primary node controller 206′ (e.g., indicating when multi-bit word of data was stored, or the like).

In one embodiment, and in storing the multi-bit word of data newly obtained at S608, the primary node controller 206′ overwrites any previously-obtained multi-bit word of data written to the data structure. In this case, the derived position newly obtained at S608 can be the subject of the aforementioned determination at S320 in FIG. 3. In another embodiment, however, the multi-bit word of data newly obtained at S608 can be appended into the data structure (with its associated timestamp), and any previously-obtained multi-bit words of data written to the data structure may be retained. In this case, the derived position with the most recent timestamp (i.e. the derived position newly obtained at S608) can be the subject of the aforementioned determination at S320 in FIG. 3.

At S610, the primary node controller 206′ can extrapolate from the derived position obtained at S606 the position of its corresponding actuator 204 at an extrapolation rate greater than the update rate. For example, the extrapolation rate can be up to 100 MHz or thereabout. Thus, the primary node controller 206′ can derive position units for an actuator 204 corresponding to a secondary node controller 206″ at a rate of up to 100 MHz (or thereabout). The result of the extrapolation is a position data unit representing a derived position of an actuator 204, and can be stored at the primary node controller 206′ in the data structure in association with the corresponding secondary node controller 206″ from which the hybrid position data packet was received and, optionally, also in association with an internal timestamp value generated by the primary node controller 206′ (e.g., indicating when multi-bit word of data was stored, or the like).

In one embodiment, and in storing the position data unit newly obtained at S610, the primary node controller 206′ overwrites any previously-obtained position data unit written to the data structure. In this case, the derived position newly obtained at S610 can be the subject of the aforementioned determination at S320 in FIG. 3. In another embodiment, however, the position data unit newly obtained at S610 can be appended into the data structure (with its associated timestamp), and any previously-obtained position data unit written to the data structure may be retained. In this case, the position data unit with the most recent timestamp (i.e. the derived position newly obtained at S610) can be the subject of the aforementioned determination at S320 in FIG. 3.

After a derived position has been obtained at S608, steps S604, S606 and S608 can be performed again assuming there are more hybrid position data packets that have been, or will be conveyed, during the n^{th} synchronization period. Thus, if the current value of “m” at S608 is less than “M” (e.g., determined as indicated at S612 at which it is checked if m=M), then the current value of “m” is incremented by 1 (e.g., as indicated at S614) and steps S604, S606 and S608 can then be performed again. For example, if steps S604, S606 and S608 were performed on a 1^{st} hybrid position data packet conveyed during an n^{th} synchronization period, then the steps S604, S606 and S608 will be performed again on a 2^{nd} hybrid position data packet conveyed during the n^{th} synchronization period, and then again on a 3^{rd} hybrid position data packet conveyed during the n^{th} synchronization period, and so on, until the last hybrid position data packet (where “m”=“M”) conveyed during the n^{th} synchronization period has been processed.

When “m” is equal to “M,” then the sets of bits accumulated at S604 for the M partial position data packets is stored as synchronization position data unit fully describing the position of the actuator 204 associated with the secondary node controller 206″ at a synchronization timepoint associated with the n^{th} synchronization period. See S616 at which the following step is implemented: set accumulated partial position data packets as reconstructed synchronization position data unit of n^{th} synchronization period.

This synchronization position data unit can be stored at the primary node controller 206′ in a data structure in association with the secondary node controller 206″ from which it was transmitted. Any pre-existing synchronization position data unit (associated with an n-1^{th} synchronization period) stored in the data structure is overwritten with this newly accumulated synchronization position data unit (associated with the n^{th} synchronization period).

After or when the synchronization position data unit associated with the n^{th} synchronization period is stored at S616, the current value of “n” at S616 is incremented by 1 (e.g., as indicated at S618 at which n is incremented by 1), the value of “m” is set to 1 (e.g., as indicated at S602), and the aforementioned steps S604, S606, S608, . . . . S618, can then be performed again for the M hybrid position data packets conveyed during synchronization periods following the n^{th} synchronization period (e.g., until the PSO application has been completely executed).

In the event that “n” is equal to 1, then there will be no synchronization position data unit associated with a preceding synchronization period and, so, there is no pre-stored synchronization position data unit to which the displacement data unit for the m^{th} hybrid position data packet of the 1^{st} synchronization period can be added. Thus, when n is equal to 1 (e.g., as when the secondary node controller 206″ initially enters “normal” mode), step S604 is performed, but steps S606, S608 and S610 may be omitted.

As mentioned above, the secondary node controller 206″—like conventional servo drivers—has an inherent maximum frequency response which, in practice, places an upper limit on the resolution of position feedback that can be obtained from the secondary node controllers 206″. For example, at an update rate of 5 MHz (or thereabout), about 20 bits can be reliably transmitted by the secondary node controller 206″. However, a position data unit will typically be much longer than 20 bits in order to represent a position of its corresponding actuator 204 with an acceptable level of resolution. Accordingly, and as should be appreciated from the foregoing, embodiments of the present invention avoid the constraints associated with the maximum frequency response by transmitting a series of relatively small hybrid position data packets each containing a few bits of a synchronization position data unit (i.e., the partial position data packet) that fully describes the position of an actuator 204 at a synchronization timepoint and a relatively small number of bits for a displacement data unit that describes (at an acceptable level of resolution) a displacement in the position of the actuator 204 at an update timepoint occurring after the synchronization timepoint. The relatively small number of bits in each hybrid position data packet can be reliably transmitted by the secondary node controller 206″ at the update rate. Therefore, and as discussed above with respect to S606 and S608, the primary node controller 206′ can derive the position of an actuator 204 at an acceptable resolution, based on a displacement data unit of an update timepoint and a synchronization position data unit of a preceding synchronization timepoint, at the update rate.

Because the position of the actuator 204 can be determined at an update rate (e.g., by performing the acts at S606 and S608) that is much higher than the synchronization rate at which a complete set of partial position data packets fully representing a synchronization position data unit can be accumulated (e.g., by performing the acts at S604), extrapolated positions of the actuator 204 (e.g., obtained at S610) can be more accurate than positions simply extrapolated from a synchronization position data unit.

### IV. Embodiments Concerning Operational Modes

As mentioned above, the duty cycle of the synchronization signal, received at a secondary node controller 206″ from the primary node controller 206′, instructs the secondary node controller 206″ as to the manner in which it should be operated: according to a “stand-by” mode; a “training” mode, or a “normal” mode.

i. Stand-by Mode

If the synchronization signal output by the primary node controller 206′ is in a fixed logic state for at least four consecutive synchronization periods, then the secondary node controller 206″ is placed into a stand-by mode and it is assumed that no PSO application is to be executed.

ii. Training Mode

The aforementioned “training” mode, into which a secondary node controller 206″ can be induced, is used to allow the primary node controller 206′ to compensate for skew between the various signals transmitted over the DataOdd, DataEven and BitClock lines from the secondary node controller 206″. The training mode can also be used to allow the primary node controller 206′ to compensate for fixed delays in the communication link 212 between the primary node controller 206′ and the secondary node controller 206″.

To induce a secondary node controller 206″ into training mode, the primary node controller 206′ transmits a training mode signal to the secondary node controller 206″ by way of the Synchronization line.

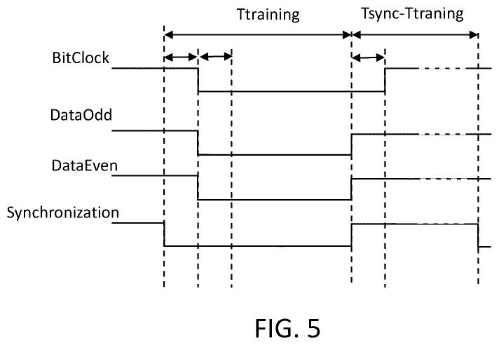

From bottom to top on FIG. 5 are represented the Synchronization line, DataEven, DataOdd and BitClock signals.

Generally, the training mode signal may be a signal (e.g., a 200 kHz signal) with a logic ‘0’ state during a Ttraining period, see FIG. 5. The duration of Ttraning can be equal to, or at least above equal to, the duration of the update period, Tupdate. Upon receiving four consecutive training signals from the primary node controller 206′, the secondary node controller 206″ enters into training mode, and will synchronize the incoming training signal to its internal bit clock and transmit a bit clock training signal back to the primary node controller 206′ on the BitClock line. The secondary node controller 206″ will also output logic ‘1’ state signals (except for a short period, e.g., 10 ns in duration) synchronized with the falling edge of the bit clock training signal. See, e.g., FIG. 5. Upon receiving the signals from each secondary node controller 206″, the primary node controller 206′ measures the drift between the three signals transmitted by the secondary node controller 206″ and compensates for any measured drift.

iii. Normal Mode

The aforementioned “normal” mode, into which a secondary node controller 206″ can be induced, is used to enable the secondary node controller 206″ to send the position feedback signals to the primary node controller 206′ (e.g., as discussed above).

To induce a secondary node controller 206″ into normal mode, the primary node controller 206′ transmits the aforementioned synchronization signal to the secondary node controller 206″ by way of the Synchronization line. The synchronization signal is in a logic ‘1’ state except for a relatively short period of time (e.g., equal to, or least about equal to, duration of half an update period, Tupdate/2)) during which the synchronization signal in a logic ‘0’ state. Upon receiving four consecutive synchronization signals from the primary node controller 206′, the secondary node controller 206″ enters into normal mode, and the secondary node controller 206″ will synchronize its internal bit clock to the incoming synchronization signal and transmit and transmit the aforementioned position feedback signal as discussed above with respect to S316 in FIG. 3. In this case, the transition from the logic ‘1’ state to the logic ‘0’ state of the synchronization signal defines the aforementioned synchronization timepoint of a synchronization period.

In transmitting the position feedback signal as discussed above with respect to S316 in FIG. 3, the secondary node controller 206″ can clock out data on the rising edge of the bit clock signal while the primary node controller 206′ can clock in data on the falling edge of the bit clock signal.

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention.

For example, in view of the foregoing, it should be appreciated that the processes described with respect to FIG. 6 can be broadly considered as a type of data compression algorithm in which each secondary node controller 206″ encodes information relating to the position of its corresponding actuator 204 using fewer bits than the actual representation of the position (e.g., as output by the encoder of the actuator 204). The primary node controller 206′ then decodes the compressed information transmitted by each secondary node controller 206″, optionally extrapolates position information based on the information, and executes a PSO application as appropriate. It will be appreciated, however, that other lossy or lossless compression algorithms may be used instead of, or in addition to, the algorithm described in FIG. 6. Accordingly, it should be recognized that any secondary node controller 206″ can encode information relating to the position of its corresponding actuator 204 by any suitable or known lossy or lossless compression technique, and that the primary node controller 206′ can decode the compressed information transmitted by any secondary node controller 206″ by any suitable or known decompression technique.

Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

### LIST OF REFERENCE SIGNS

200 system
201 system controller
202 tool/device
203 motion machine interface
204, 204a, 204b, 204c actuator
205 network
206, 206a, 206b, 206c node controllers
206′ primary node controller
206″ secondary node controller
207 communication links
208 arrow
210 arrow
212 communication links
214 arrow
300 process
402 common synchronization period
402_1 first hybrid position data packet
402_25 twenty-fifth hybrid position data packet
404 synchronization period
404_25 twenty-fifth hybrid position data packet
406a start period
406b end period
600 process
S302 step
S304 step
S306 step
S308 step
S310 step
S312 step
S314 step
S316 step
S318 step
S320 step
S322 step
S602 step
S604 step
S606 step
S608 step
S610 step
S612 step
S614 step
S616 step
S618 step

1. A control system for controlling a device operative to perform an operation on a workpiece based on a spatial relationship between the device and the workpiece, wherein the spatial relationship is adjustable using at least one actuator, the control system comprising:
a primary node controller communicatively coupled to the device, wherein the primary node controller is adapted to control an operation of the device; and
at least one secondary node controller communicatively coupled to the primary node controller, wherein the at least one secondary node controller is adapted to:
receive encoder feedback from the at least one actuator, the encoder feedback representing a position of a mechanical load associated with an actuator of the at least one actuator;
perform a data compression algorithm on the encoder feedback to encode the encoder feedback;
generate a plurality of data packets representing the encoder feedback and transmit the plurality of data packets,
wherein the primary node controller is further adapted to:
receive the plurality of data packets,
decode the plurality of data packets as a plurality of decoded data packets, and
control an operation of the device based, at least in part, on the plurality of decoded data packets.

2. The control system of claim 1, further comprising the device.

3. The control system of claim 2, wherein the device includes at least one selected from the group consisting of a laser and a sensor.

4. The control system of claim 1, further comprising the at least one actuator.

5. The control system of claim 4, wherein the at least one actuator includes a linear actuator.

6. The control system of claim 4, wherein the at least one actuator is mechanically coupled to the workpiece.

7. The control system of claim 1, further comprising a plurality of secondary node controllers.

8. The control system of claim 7, further comprising a plurality of actuators.

9. A system, comprising;
a laser configured emit a laser pulse propagating along a propagation path to irradiate a workpiece;
at least one actuator configured to support the workpiece; and
a control system for controlling the laser to emit the pulse based on a spatial relationship between the propagation path and the workpiece, wherein the spatial relationship is adjustable using the at least one actuator, the control system comprising:
a primary node controller communicatively coupled to the laser, wherein the primary node controller is adapted to control an operation of the laser; and
at least one secondary node controller communicatively coupled to the primary node controller, wherein the at least one secondary node controller is adapted to:
receive encoder feedback from the at least one actuator, the encoder feedback representing a position of a mechanical load associated with the at least one actuator;
perform a data compression algorithm on the encoder feedback to encode the encoder feedback;
generate a plurality of data packets representing the encoder feedback and transmit the plurality of data packets,
wherein the primary node controller is further adapted to:
receive the plurality of data packets,
decode the plurality of data packets as a plurality of decoded data packets, and
control an operation of the laser based, at least in part, on the plurality of decoded data packets.

10. The control system of claim 9, further comprising a plurality of secondary node controllers.

11. The control system of claim 10, further comprising a plurality of actuators.

12. A motion system, comprising;
a first actuator; and
a control system for controlling a device to perform an operation on a workpiece based on a spatial relationship between the device and the workpiece, wherein the spatial relationship is adjustable using the first actuator, the control system comprising:
a primary node controller communicatively coupled to the first actuator, wherein the primary node controller is adapted to control an operation of the device; and
at least one secondary node controller communicatively coupled to the primary node controller, wherein the at least one secondary node controller is adapted to:
receive encoder feedback from the first actuator, the encoder feedback representing a position of a mechanical load associated with the first actuator;
perform a data compression algorithm on the encoder feedback to encode the encoder feedback;
generate a plurality of data packets representing the encoder feedback and transmit the plurality of data packets,
wherein the primary node controller is further adapted to:
receive the plurality of data packets,
decode the plurality of data packets as a plurality of decoded data packets, and
control an operation of the device based, at least in part, on the plurality of decoded data packets.

13. The motion system of claim 12, further comprising at least one second actuator.

14. The motion system of claim 12, wherein the device includes at least one selected from the group consisting of a laser and a sensor.

15. The motion system of claim 12, further comprising a plurality of secondary node controllers and a plurality of actuators, wherein each of the plurality of actuators is associated with a respective secondary node controller of the plurality of secondary node controllers.

16. A non-transitory computer-readable medium for use with a control system, having a memory which, when executed by the control system, causes the control system to:
control a device operative to perform an operation on a workpiece based on a spatial relationship between the device and the workpiece, wherein the spatial relationship is adjustable using at least one actuator, wherein the control system comprises:
a primary node controller communicatively coupled to the device, wherein the primary node controller is adapted to control an operation of the device; and
at least one secondary node controller communicatively coupled to the primary node controller, wherein the at least one secondary node controller is adapted to:
receive encoder feedback from the at least one actuator, the encoder feedback representing a position of a mechanical load associated with an actuator of the at least one actuator;
perform a data compression algorithm on the encoder feedback to encode the encoder feedback;
generate a plurality of data packets representing the encoder feedback and
transmit the plurality of data packets,
wherein the primary node controller is further adapted to:
receive the plurality of data packets,
decode the plurality of data packets as a plurality of decoded data packets, and
control an operation of the device based, at least in part, on the plurality of decoded data packets.

17. The non-transitory computer-readable medium of claim 16, further comprising a plurality of secondary node controllers.

18. The control system of claim 17, further comprising a plurality of actuators.
